(19) United States
(12) Patent Application Publication
(10) Pub. No.: US 2005/0031267 A1
(43) Pub. Date: Feb. 10, 2005

(54) Branch optical wave-guide

(76) Inventor: Tsutomu Sumimoto, Kanagawa (JP)

Correspondence Address: MANELLI DENISON & SELTER, 2000 M STREET NW SUITE 700, WASHINGTON, DC, 20036-3307, US

(21) Appl. No.: 10/898,165

(22) Filed: Jul. 26, 2004

(30) Foreign Application Priority Data
Aug. 5, 2003 (JP) JP2003-286701

(51) Int. Cl. G02B 6/26

(52) U.S. Cl. 385/45

(57) ABSTRACT

When the longitudinal central axis line of a first linear wave-guide 2 that receives light is set to be a reference line, open portions of circular arcs of first curved wave-guides 4a, 4b that are coupled to a tapered wave-guide 3 face outward when viewed from the reference line. On the other hand, open portions of circular arcs of second curved wave-guides 5a, 5b that are coupled to the first curved wave-guides 4a, 4b face inward when viewed from the reference line. Furthermore, second linear wave-guides 6a, 6b, which are coupled to the first linear wave-guide through the first and second curved wave-guides, and the reference line X are outwardly coupled to form an angle, which is set to be greater than 0 degree. According to the present invention, there can be provided a branch optical wave-guide that can make its entire length short with polarization property of respective output ports equalized.

This application claims priority to Japanese Patent Application No. 2003-286701, filed Aug. 5, 2003, the complete disclosure of which is incorporated herein by reference.

### BACKGROUND OF THE INVENTION

1. Field of the Invention

The present invention relates to a branch optical wave-guide whose entire length is short and whose polarization dependence is low.

2. Description of Related Art

Recently, as the Internet is coming into wide use, the need of improving the communication networks is significantly increasing. Optical wave-guides are used in optical fiber networks of main lines or network users to construct the optical communication networks.

In an optical communication network, branch optical wave-guides are used to split an optical signal and direct thus split optical signals to plural circuits, or to composite optical signals incident from plural circuits and direct thus composite optical signal to an optical wave-guide. For example, a Y-branch optical wave-guide is well known as a typical branch optical wave-guide.

A Y-branch optical wave-guide has a linear optical wave-guide, a tapered wave-guide that is coupled to one end of the linear optical wave-guide and splits light, and two optical waveguide that are coupled to the tapered optical branch (Japan Patent Laid-Open Publication No. 5-11130).

By combining a plurality of such Y-branch optical wave-guides, a branch optical wave-guide of 1×4, . . . 1×N configuration can be formed. When each of two optical wave-guides of a Y-branch optical wave-guide, which are divided by a tapered optical branch path, has its end coupled to another Y-branch optical wave-guide respectively, a branch optical wave-guide of 1×4 configuration can be formed. Conventionally, there are known branch optical wave-guides that have their tapered branch paths coupled to curved wave-guides and linear wave-guides (Japan Patent Laid-Open Publications No. 4-213407 and No. 4-289803).

In the aforementioned conventional technique, there are raised following problems to be solved.

According to the Y-branch optical wave-guide path disclosed in Japan Patent Laid-Open Publication No. 5-11130, the length of the wave-guide becomes undesirably too long as a whole. So, there is a problem that, when using a branch optical wave-guide having a plurality of Y-branch optical wave-guides mutually combined, the resulting entire length cannot be disregarded.

According to the branch optical wave-guide disclosed in Japan Patent Laid-Open Publication No.4-213407, having curved wave-guides and linear wave-guides combined, polarization property of respective output side wave-guides is favorable. However, similarly, the length of thus configured wave-guide becomes undesirably too long as a whole.

On the other hand, there is disclosed a technique in Japan Patent Laid-Open Publication No. 4-289803 which is designed to reduce the entire length of a wave-guide. According to the technique, linear wave-guides included in a branch optical wave-guide are arranged along predetermined directions as getting near to the end part of the branch optical wave-guide so as to reduce the entire length. However, under this configuration, there is a problem that unequivalent polarization property is observed in respective output side wave-guides.

### SUMMARY OF THE INVENTION

To solve the conventional problems as mentioned above, the present invention provides a branch optical wave-guide that can make its entire length short with polarization property favorably equalized.

According to the present invention, there is provided a branch optical wave-guide including: a first linear wave-guide; a tapered optical wave-guide for receiving light from a first linear wave-guide and splitting the received light, which is coupled to the first linear wave-guide; and a plurality of branched circuits each having a first curved wave-guide, a second curved wave-guide, and a second linear wave-guide coupled in this order, which are coupled to the tapered wave-guide, wherein, when the central axis line of the first linear waveguide is set to be a reference line, an open portion of a circular arc that is formed by the central axis line of the first curved wave-guide is coupled to face outward when viewed from the reference line, while an open portion of a circular arc that is formed by the central axis line of the second curved waveguide is coupled to face inward when viewed from the reference line, and wherein the central axis line of the second linear wave-guide and the reference line form an angle, which is set to be greater than 0 degree, and the second curved wave-guide and the second linear waveguide are coupled such that the central axis line of the second linear wave-guide gets away from the reference line as the second linear wave-guide gets away from the coupling point with the second curved wave-guide.

According to the branch optical wave-guide, when the first curved wave-guide and the second curved optical waveguide path are coupled, and the second curved wave-guide and the second linear wave-guide are coupled, the respective wave-guides are put together and coupled to each other with their central axis lines unmatched with each other by a predetermined deviance amount.

According to the branch optical wave-guide, a wave-guide for changing directions of optical paths is arranged between a optical wave-guide circuit, which is formed by coupling a plurality of branch optical wave-guides in the branch-forming manner, and an optical wave-guide array having a plurality of parallel optical wave-guides so as to make light split and transmitted through linear wave-guides substantially parallel with the reference line.

According to the branch optical waveguide, which combines a plurality of branch optical waveguides, the linear wave-guides of the respective branch optical wave-guides are mutually coupled to each other such that a linear wave-guide directly coupled to a curved wave-guide of one branch optical wave-guide is put together and coupled to a linear wave-guide directly coupled to a tapered wave-guide of another branch wave-guide.

According to the branch optical wave-guide, which combines a plurality of branch optical wave-guides, the respective branch optical wave-guides are mutually coupled to each other such that a linear wave-guide directly coupled to a curved wave-guide of one branch optical wave-guide and a linear wave-guide directly coupled to a tapered wave-guide of another branch optical wave-guide are united into one linear wave-guide.

According to the branch optical wave-guide, which further includes: a second tapered wave-guide for receiving light from the second linear wave-guide and splitting the received light, which is coupled to the second linear wave-guide; and a plurality of branched circuits each having a third curved wave-guide, a fourth curved wave-guide, and a third linear wave-guide coupled in this order, which are coupled to the second tapered wave-guide, when the central axis line of the second linear wave-guide is set to be a second reference line, an open portion of a circular arc that is formed by the central axis line of the third curved wave-guide is coupled to face outward when viewed from the second reference line, while an open portion of a circular arc that is formed by the central axis line of the fourth curved wave-guide is coupled to face inward when viewed from the second reference line, and the central axis line of the third linear wave-guide and the second reference line form an angle, which is set to be greater than 0 degree, and the fourth curved wave-guide and the third linear wave-guide are coupled such that the central axis line of the third linear wave-guide gets away from the second reference line as the third linear wave-guide gets away from the coupling point with the fourth curved wave-guide.

According to the branch optical wave-guide, when the first curved wave-guide and the second curved wave-guide are coupled, and the second wave-guide and the second linear wave-guide are coupled, the respective wave-guides are put together and coupled to each other with their central axis lines unmatched with each other by a predetermined deviance amount, and when the third curved wave-guide and the fourth curved wave-guide are coupled, and the fourth curved wave-guide and the third linear wave-guide are coupled, the respective wave-guides are put together and coupled to each other with their central axis lines unmatched with each other by a predetermined deviance amount.

According to the branch optical wave-guide, a wave-guide for changing directions of optical paths is arranged between the optical wave-guide circuit, which is formed by coupling a plurality of branch optical wave-guides in the branch-forming manner, and an optical wave-guide array having a plurality of parallel optical wave-guides so as to make light split and transmitted through linear wave-guides substantially parallel with the reference line.

### BRIEF DESCRIPTION OF THE DRAWINGS

The above and other objects, advantages and features of the present invention will be more apparent from the following description taken in conjunction with the accompanying drawings in which:

FIG. 1 shows a schematic view of an embodiment of the branch optical wave-guide according to the present invention;

FIG. 2 shows a schematic view of another embodiment of the branch optical wave-guide according to the present invention;

FIG. 3 shows an explanatory diagram for explaining the method of combining the branch optical wave-guides;

FIG. 4 shows an explanatory diagram for explaining the method of outputting light from the branch optical wave-guide;

FIG. 5 shows polarization property of the 1×4 type branch optical wave-guide; and

FIG. 6 shows an explanatory diagram for explaining the method of coupling the respective wave-guides of the branch optical wave-guide according to the present invention.

### DETAILED DESCRIPTION OF THE PREFERRED EMBODIMENTS

Best modes of carrying out the present invention will be described in further detail using various embodiments with references to the accompanying drawings.

Next, details explain the embodiments regarding implementation aspects.

[First Embodiment]

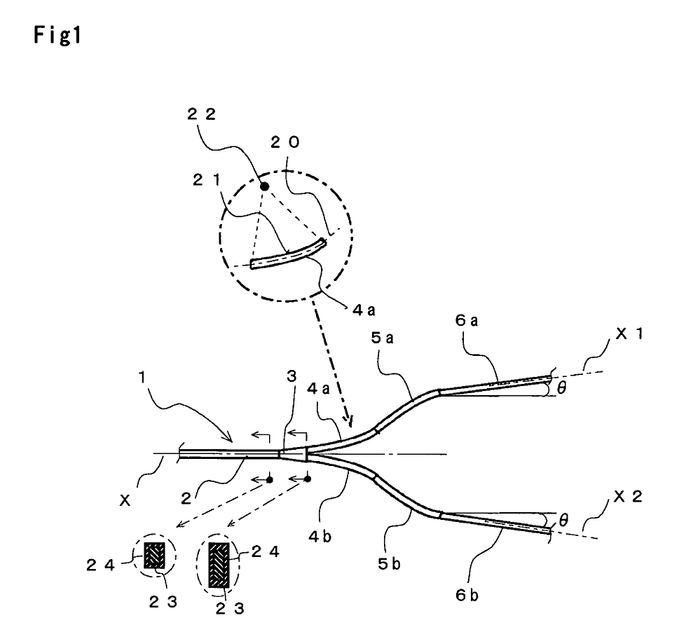

FIG. 1 shows an embodiment of the branch optical wave-guide according to the present invention.

As shown in FIG. 1, a branch optical wave-guide 1 of the embodiment has a first linear wave-guide 2 for receiving light, and a tapered branch path 3 that is coupled to the first linear wave-guide 2 and splits light. There is shown an enlarged cross-sectional view of the first linear wave-guide 2 in a left side chain-line circle at the lower left of FIG. 1. The first linear wave-guide 2 has a core 23 and a clad 24. Light is transmitted through the core 23. There is shown an enlarged cross-sectional view of the right end of the tapered branch path 3 in a right side chain-line circle at the lower left of FIG. 1. The tapered branch path 3 is tapered to enlarge the cross-section area of the core 23, so as to split light transmitted through the first linear wave-guide 2. In this embodiment, light is received at the left end of the first linear wave-guide 2 to be transmitted rightward in FIG. 1.

The tapered branch path 3 has its end coupled to ends of first curved wave-guides 4a, 4b. The first curved wave-guides 4a, 4b have their other ends coupled to ends of second curved wave-guides 5a, 5b, respectively. Thus, the branch optical wave-guide 1 has a branched circuit having the first curved wave-guide 4a, the second curved wave-guide 5a, and a second linear wave-guide 6a, coupled in this order. Furthermore, the branch optical wave-guide 1 has another branched circuit having the first curved wave-guide 4b, the second curved wave-guide 5b, and a second linear wave-guide 6b, coupled in this order. Having a pair of these branched circuits, the branch optical wave-guide 1 configures a Y-branch optical wave-guide. The branch optical wave-guide 1 is formed on a basal plate, not shown.

In the branch optical wave-guide 1, the central axis line of the first linear wave-guide 2 corresponds to a line on the basis of which the Y-branch optical wave-guide becomes ax symmetric. The central axis line is referred to as a reference line X, hereinafter. There is shown an enlarged side view of the first curved wave-guide 4a in a chain-line circle at the upside of FIG. 1. As shown in the enlarged side view, an open portion 21 of a circular arc 20 that is formed by the central axis line of the first curved wave-guide 4a faces outward when viewed from the reference line X. The circular arc 20 of the first curved wave-guide 4a is formed by following the cross-section center of the first curved wave-guide 4a along the longitudinal direction, as shown by a chain-line. The open portion 21 of the circular arc 20 of the first curved wave-guide 4a is a side of the first curved wave-guide 4a which faces the center 22 of the circular arc 20. Facing outward when viewed from the reference line X indicates facing a direction getting away from the reference line X, while facing inward when viewed from the reference line X indicates facing a direction getting near to the reference line X.

Furthermore, an open portion of a circular arc that is formed by the central axis line of the second curved wave-guide 5a, which is coupled to the first curved wave-guide 4a, faces inward when viewed from the reference line X. That is, as for the first curved wave-guide 4a, the distance from the reference line X to the center 22 of the circular arc 20 is longer than that from the reference line X to the first curved wave-guide 4a. On the other hand, as for the second curved wave-guide 5a, the distance from the reference line X to the center 22 of the circular arc 20 is shorter than that from the reference line X to the second curved wave-guide 5a. Accordingly, the first curved wave-guide 4a and the second curved wave-guide 5a form an S-shaped wave-guide as a whole. The tapered branch path 3 has its output side end coupled to the S-shaped wave-guide so as to equalize polarization property, as will be described later. Similarly, the first curved wave-guide 4b and the second curved wave-guide 5b form an S-shaped wave-guide as a whole.

Next, coupling directions of the second linear wave-guide 6a and the second linear wave-guide 6b will be explained. The central axis line X1 of the second linear wave-guide 6a and the reference line X form an angle θ, which is set to be greater than 0 degree. The second curved wave-guide 5a and the second linear wave-guide 6a are coupled such that the central axis line X1 of the second linear wave-guide 6a gets away from the reference line X as the second linear wave-guide 6a gets away from the coupling point with the second curved wave-guide 5a. Similarly, the central axis line X2 of the second linear wave-guide 6b and the reference line X form an angle θ, which is set to be greater than 0 degree. The second curved wave-guide 5b and the second linear wave-guide 6b are coupled such that the central axis line X2 of the second linear wave-guide 6b gets away from the reference line X as the second linear wave-guide 6b gets away from the coupling point with the second curved wave-guide 5b.

In the Y-branch optical wave-guide shown in FIG. 1, to equalize polarization property of optical signals transmitted through the tapered branch path 3 and a pair of these branched circuits, configuration to couple these branched circuits is optimized. The first curved wave-guide 4a and the second curved wave-guide 5a form an S-shaped wave-guide on a plane where an optical circuit is formed. It is desired that radiuses of curvature of the circular arcs of the first curved wave-guides 4a, 4b, and radiuses of curvature of the circular arcs and entire lengths of the second curved wave-guides 5a, 5b be optimally selected in view of materials of the wave-guides and the wavelength and intensity of optical signals to be transmitted. According to experimental tests, it is known that, in case of splitting an optical signal in the Y-shape-forming manner using the tapered branch path 3, as shown in FIG. 1, mode distribution of light can be optimized when the direction of the second linear wave-guide 6a and the second linear optical wave-guide path 6b are arranged to form Y-shape. That is, it is desired that the angle θ is set up such that the central axis lines X1, X2 of the second linear wave-guides 6a, 6b get away from the reference line X as the second linear wave-guides 6a, 6b get away from the coupling point with the second curved wave-guides 5a, 5b.

[Second Embodiment]

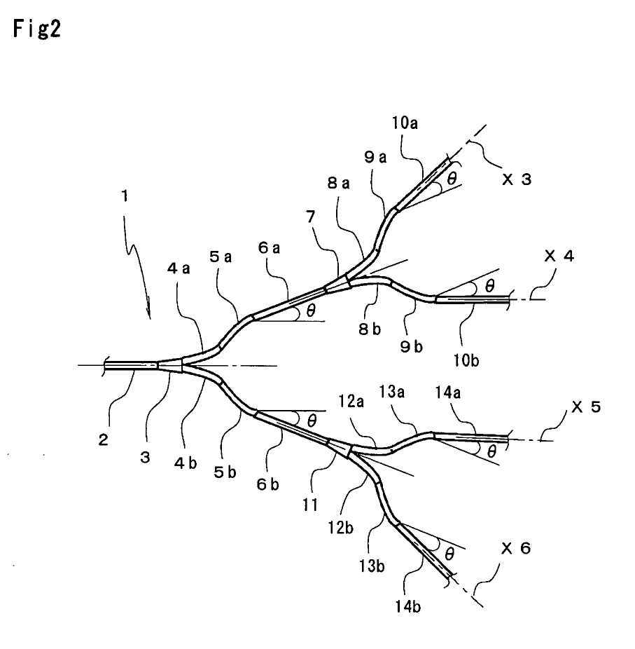

FIG. 2 shows another embodiment of the branch optical wave-guide according to the present invention. In FIG. 2, parts or components similar to those shown in FIG. 1 are indicated with the same reference numerals.

The branch optical wave-guide shown in FIG. 2 is of 1×4 type. The second linear wave-guide 6a of the branch optical wave-guide 1 shown in FIG. 1 has its end coupled to a second tapered branch path 7. The second tapered branch path 7 has its end coupled to third curved wave-guides 8a, 8b, and then fourth curved wave-guides 9a, 9 b in this order, respectively. Furthermore, the fourth curved wave-guides 9a, 9 b have their ends coupled to third linear wave-guides 10a, 10b, respectively. On the other hand, the second linear wave-guide 6b has its end coupled to a second tapered branch path 11. The second tapered branch path 11 has its end coupled to third curved wave-guides 12a, 12b, and then fourth curved wave-guides 13a, 13b in this order, respectively. Furthermore, the fourth curved wave-guides 13a, 13b have their ends coupled to third linear wave-guides 14a, 14b, respectively. Thus, according to the branch optical wave-guide, when light is received by the single first linear wave-guide 2, the light is split to be output from the four sets of third linearwave-guides 10a, 10b, 14a, 14b.

The branch optical wave-guide, which is composed of the second linear wave-guide 6a, second tapered branch path 7, third curved wave-guides 8a, 8b, fourth curved wave-guides 9a, 9b, and third linear wave-guides 10a, 10b, is designed in the same manner as the branch optical wave-guide shown in FIG. 1, which is composed of the first linear wave-guide 2, tapered branch path 3, first curved wave-guides 4a, 4b, second curved wave-guides 5a, 5b, and second linear wave-guides 6a, 6b. The other branch optical wave-guide that starts from the second linear wave-guide 6b is designed similarly. Thus, when the central axis line of the second linear wave-guide 6a is set to be a reference line, an angle θ formed by the central axis line of the third linear wave-guide 10a and the reference line is set to be greater than θ0 degree. The other linear wave-guide path is configured similarly.

[Third Embodiment]

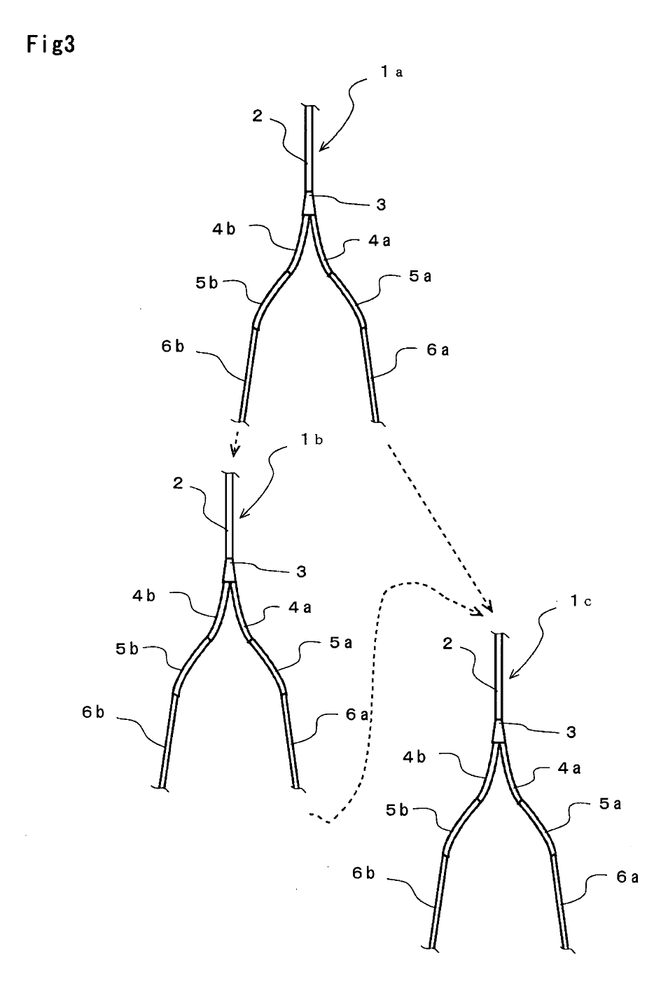

FIG. 3 shows an explanatory diagram for explaining the method of combining the branch optical wave-guides.

In FIG. 3, branch optical wave-guide paths 1a, 1b, 1c are of the same configuration as the branch optical wave-guide 1 as described above with reference to FIG. 1. For example, when the second linear wave-guide 6b directly coupled to the second curved wave-guide 5b of the branch optical wave-guide 1a is put together and coupled to the first linear wave-guide 2 directly coupled to the tapered branch path 3 of the branch optical wave-guide 1b, a triple branch optical wave-guide is formed. Furthermore, the first linear waveguide 2 of the branch optical wave-guide 1c may be coupled to the second linear wave-guide 6a of the branch optical wave-guide 1b. To reduce the size of thus completed branch optical wave-guide, when coupling the branch optical wave-guide 1a and the branch optical wave-guide 1b, it is desired that the second linear wave-guide 6a and the first linear wave-guide 2, which are put together and coupled to each other, be united into one linear optical wave-guide. As a result, a quadruple branch optical wave-guide is formed, as shown in FIG. 2.

Since the angle θ formed by the central axis line of the linear wave-guide before being divided and the central axis line of the linear wave-guide after being divided is set to be greater than 0 degree, when a plurality of branch optical wave-guides are coupled on a planar basal plate in above-described branch-forming manner, two divided linear wave-guides of adjacent branch optical wave-guides do not cross, realizing multiple branching. For example, in FIG. 2, even though the third linear wave-guides 10a, 14b are divided by other branch optical wave-guides, thus formed two pairs of two linear wave-guides do not cross on a planar basal plate. On the other hand, the third linear wave-guides 10b,14a do not have to be divided any more. In this manner, according to the present invention, a branch optical wave-guide of 1×8 type, 1×16 type, 1×N type can be formed other than that of 1×4 type shown in FIG. 2.

[Fourth Embodiment]

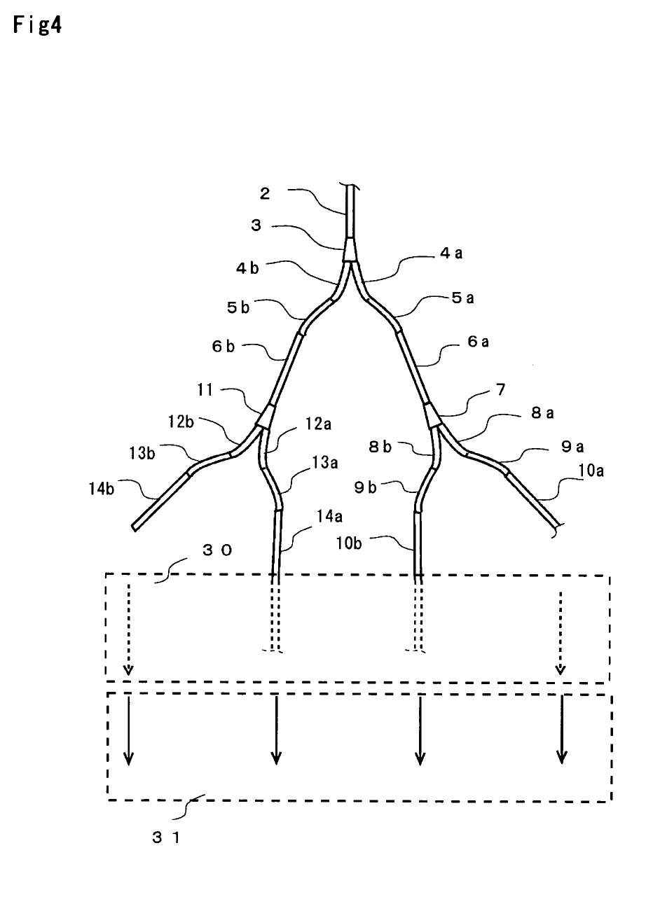

FIG. 4 shows an explanatory diagram for explaining the method of outputting light from the branch optical wave-guide.

Generally, the optical wave-guide circuit has its ends coupled to an optical wave-guide array. Pluralities of optical wave-guides of the optical wave-guide array are arranged substantially in parallel with the reference line X shown in FIG. 1. On the other hand, the third linear wave-guides 10a, 10b, 14a, 14b located at the right side of the branch optical wave-guide shown in FIG. 2 are not parallel with each other. Thus, it is desired that a wave-guide 30 for changing directions of optical paths be arranged between the branch optical wave-guide of the present invention and an optical wave-guide array 31 having a plurality of parallel optical wave-guides so as to make light split and transmitted through linear wave-guides substantially parallel with the reference line X with transmission mode change of optical signals split and transmitted through the third linear wave-guides 10a, 10b, 14a,14b suppressed. This can be realized by optical fibers or optical wave-guides having the same property as the optical fibers. Accordingly, the branch optical wave-guide according to the present invention can be used at part of various optical wave-guide circuits.

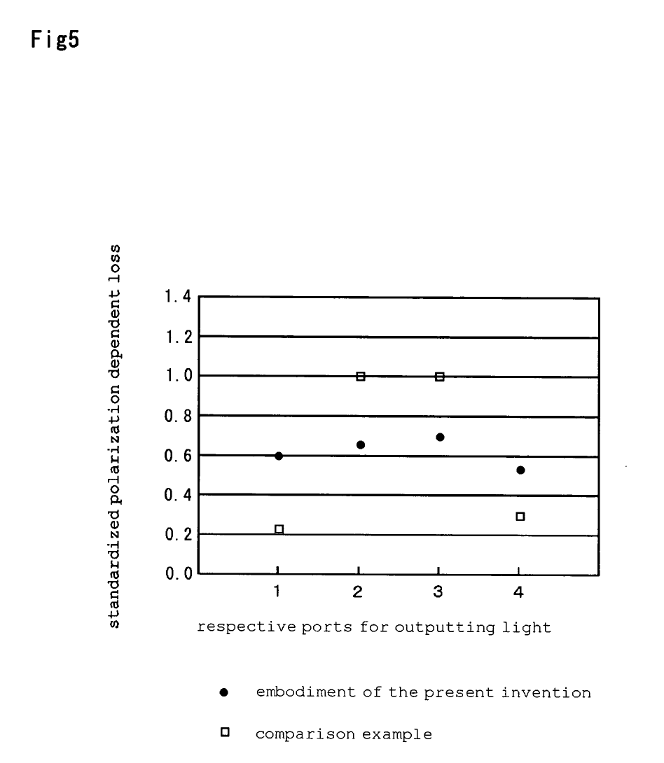

FIG. 5 shows polarization property of the 1×4 type branch optical wave-guide shown in FIG. 2. In the graphical representation, the ordinate axis shows standardized polarization dependent loss, while the abscissa axis shows respective ports for outputting light or output side optical wave-guides. Output port numbers of the third linear wave-guides 10a, 10b, 14a, 14b are denoted by “1”, “2”, “3”, and “4”, respectively. For comparison, a branch optical wave-guide shown in Japan Patent Laid-Open Publication No. 4-289803 is prepared and its polarization property is measured. A black circle “●” shows outputs of the embodiment of the present invention, while those of a comparison example are shown by a square “□”. The standardized polarization dependent loss is data indicative of transmission loss level of light generated depending on polarization. As is apparent from the graphical representation, according to the branch optical wave-guide of the present invention, fluctuation of polarization dependent loss of the respective output ports is significantly small as compared with the comparison example.

The conceivable reason is as follows. In a linear wave-guide, mode distribution of light transmitted through the wave-guide is located at the center thereof and is stable. On the other hand, in a curved wave-guide of a small radius of curvature, mode distribution of light transmitted through the wave-guide shifts to the outside of a circular arc thereof. Furthermore, in a tapered wave-guide, high order mode is generated. Thus, in general, mode distribution of light transmitted through the tapered wave-guide 3 and the first curved wave-guides 4a, 4b windles. It progresses meanderingly. So, as for the following wave-guide, branch ratio has polarization dependence depending on extent of the windle of mode distribution. The polarization dependence of branch ratio deteriorates polarization property between respective output ports, and makes the polarization property unequivalent. So, according to the present invention, the second curved wave-guide is coupled to the first curved wave-guide so as to form the S-shaped wave-guide, which can stable mode of light, thereby improving polarization property between respective output ports.

[Fifth Embodiment]

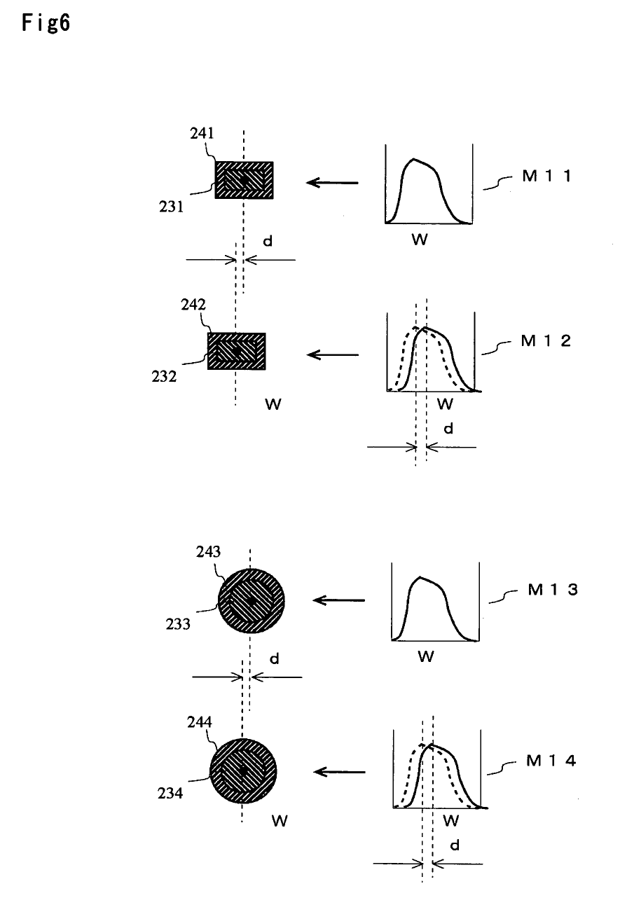

FIG. 6 shows an explanatory diagram for explaining the method of coupling the respective wave-guides of the branch optical wave-guide of the present invention. In FIG. 6, the left side shows cross-sectional views of optical wave-guides, while the right side shows graphical representations indicative of light intensity distribution in the effective width W range of the optical wave-guides.

Above-described optical wave-guide circuits are formed on a silica glass basal plate of several-mm-square to several-tens-mm-square. It is desired that the first curved wave-guides 4a, 4b and the second curved wave-guides 5a, 5b shown in FIG. 1 be coupled with their central axis lines unmatched with each other. Similarly, the second curved wave-guides 5a, 5b and the second linear wave-guides 6a, 6b shown in FIG. 1 coupled with their central axis lines unmatched with each other. The left side cross-sectional views of FIG. 6 show, from above, output end of an optical wave-guide of rectangular cross section, input end of an optical wave-guide of rectangular cross section, output end of an optical wave-guide of circular cross section, and input end of an optical wave-guide of circular cross section, respectively. For example, the output end of the first curved wave-guide 4a shown in FIG. 1 has a core 231 and a clad 241, while the input end of the second curved wave-guide 5a has a core 232 and a clad 242, as shown in FIG. 6.

It is assumed that mode distribution is somewhat deviated to the left at the output end of the first curved wave-guide 4a, as shown in M11 of FIG. 6. At this time, at the coupling point of the first curved wave-guide 4a and the second curved wave-guide 5a, the respective corresponding central axis lines of the wave-guides are made to be unmatched with each other by a predetermined deviance amount “d”. Thus, it becomes possible to shift mode distribution of light coming into the second curved wave-guide 5a to the center of the wave-guide, as shown in M12 of FIG. 6. The deviance amount between these central axis lines varies depending on the radius of curvature or length of the curved wave-guide, and the optimum deviance amount may be calculated every designing of products. The output end of an optical wave-guide of circular cross section and the input end of an optical wave-guide of circular cross section may be coupled to each other similarly. For example, the output end of the first curved wave-guide 4a shown in FIG. 1 has a core 233 and a clad 243, while the input end of the second curved wave-guide 5a has a core 234 and a clad 244, as shown in FIG. 6. It is assumed that mode distribution is somewhat deviated to the left at the output end of the first curved wave-guide 4a, as shown in M13 of FIG. 6. At this time, at the coupling point of the first curved wave-guide 4a and the second curved wave-guide 5a, the respective corresponding central axis lines of the wave-guides are made to be unmatched with each other by a predetermined deviance amount “d”. Thus, it becomes possible to shift mode distribution of light coming into the second curved wave-guide 5a to the center of the wave-guide, as shown in M14 of FIG. 6.

As in the above, even though the entire length of first and second curved wave-guides is short, it becomes possible to realize a small-sized branch optical wave-guide with its mode distribution sufficiently equalized.

1. A branch optical wave-guide comprising:
a first linear wave-guide;
a tapered wave-guide for receiving light from a first linear wave-guide and splitting the received light, which is coupled to the first linear wave-guide; and
a plurality of branched circuits each having a first curved wave-guide, a second curved wave-guide, and a second linear wave-guide coupled in this order, which are coupled to the tapered wave-guide,
wherein, when the central axis line of the first linear wave-guide is set to be a reference line, an open portion of a circular arc that is formed by the central axis line of the first curved wave-guide is coupled to face outward when viewed from the reference line, while an open portion of a circular arc that is formed by the central axis line of the second curved wave-guide is coupled to face inward when viewed from the reference line, and
wherein the central axis line of the second linear wave-guide and the reference line form an angle, which is set to be greater than 0 degree, and the second curved wave-guide and the second linear wave-guide are coupled such that the central axis line of the second linear wave-guide gets away from the reference line as the second linear wave-guide gets away from the coupling point with the second curved wave-guide.

2. The branch optical wave-guide as set forth in claim 1, wherein, when the first curved wave-guide and the second curved wave-guide are coupled, and the second curved wave-guide and the second linear wave-guide are coupled, the respective wave-guides are put together and coupled to each other with their central axis lines unmatched with each other by a predetermined deviance amount.

3. The branch optical wave-guide as set forth in claim 1, wherein a wave-guide for changing directions of optical paths is arranged between a optical wave-guide circuit, which is formed by coupling a plurality of branch optical wave-guides in the branch-forming manner, and an optical wave-guide array having a plurality of parallel optical wave-guides so as to make light split and transmitted through linear wave-guides substantially parallel with the reference line.

4. The branch optical wave-guide as set forth in claim 1, which combines a plurality of branch optical wave-guides, wherein the linear wave-guides of the respective branch optical waveguides are mutually coupled to each other such that a linear wave-guide directly coupled to a curved wave-guide of one branch optical wave-guide path is put together and coupled to a linear wave-guide directly coupled to a tapered wave-guide of another branch wave-guide.

5. The branch optical wave-guide as set forth in claim 1, which combines a plurality of branch optical wave-guides, wherein the respective branch optical wave-guides are mutually coupled to each other such that a linear wave-guide directly coupled to a curved wave-guide of one branch optical waveguide and a linear wave-guide directly coupled to a tapered wave-guide of another branch optical wave-guide are united into one linear wave-guide.

6. The branch optical wave-guide as set forth in claim 1, further comprising:
a second tapered wave-guide for receiving light from the second linear wave-guide and splitting the received light, which is coupled to the second linear wave-guide; and
a plurality of branched circuits each having a third curved wave-guide, a fourth curved wave-guide, and a third linear wave-guide coupled in this order, which are coupled to the second tapered wave-guide,
wherein, when the central axis line of the second linear wave-guide is set to be a second reference line, an open portion of a circular arc that is formed by the central axis line of the third curved wave-guide is coupled to face outward when viewed from the second reference line, while an open portion of a circular arc that is formed by the central axis line of the fourth curved waveguide is coupled to face inward when viewed from the second reference line, and
wherein the central axis line of the third linear wave-guide and the second reference line form an angle, which is set to be greater than 0 degree, and the fourth curved wave-guide and the third linear wave-guide are coupled such that the central axis line of the third linear wave-guide gets away from the second reference line as the third linear wave-guide gets away from the coupling point with the fourth curved wave-guide.

7. The branch optical wave-guide as set forth in claim 6,
wherein, when the first curved wave-guide and the second curved wave-guide are coupled, and the second curved wave-guide and the second linear wave-guide are coupled, the respective wave-guides are put together and coupled to each other with their central axis lines unmatched with each other by a predetermined deviance amount, and
wherein, when the third curved wave-guide and the fourth curved optical wave-guide path are coupled, and the fourth curved wave-guide and the third linear wave-guide are coupled, the respective wave-guides are put together and coupled to each other with their central axis lines unmatched with each other by a predetermined deviance amount.

8. The branch optical wave-guide as set forth in claim 6, wherein a wave-guide for changing directions of optical paths is arranged between the optical wave-guide circuit, which is formed by coupling a plurality of branch optical wave-guides in the branch-forming manner, and an optical wave-guide array having a plurality of parallel optical wave-guides so as to make light split and transmitted through linear wave-guides substantially parallel with the reference line.
